(19) United States
(12) Patent Application Publication
(10) Pub. No.: US 2008/0139181 A1
(43) Pub. Date: Jun. 12, 2008

(54) METHODS AND APPARATUS FOR MEASURING THE EFFECTIVENESS OF ADVERTISEMENTS PRESENTED ON A MOBILE NAVIGATION DEVICE

(75) Inventor: Anatole M. Lokshin, Huntington Beach, CA (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: MAGELLAN NAVIGATION, INC., Santa Clara, CA (US)

(21) Appl. No.: 11/840,610

(22) Filed: Aug. 17, 2007

Related U.S. Application Data
(60) Provisional application No. 60/869,217, filed on Dec. 8, 2006.

(51) Int. Cl. H04L 12/58

(52) U.S. Cl. 455/414.1

(57) ABSTRACT

A system and method for measuring the effectiveness of an advertisement presented on a mobile navigation device is described. The information is stored on the device and then accessed by a server or the advertiser. The method involves tracking device location, presenting to the user an advertisement or point of interest, storing click throughs on the advertisement or point of interest to mark a first success, and monitoring device current position to determine whether the device reaches a location associated with the advertisement or Point of interest to mark a second success, counting successes, and providing success feedback to the advertiser, for example, through server queries.

### CROSS REFERENCE TO RELATED APPLICATIONS

The present Application for Patent claims priority to U.S. Provisional Application No. 60/869,217 entitled “Advertisement Feedback on a Mobile Navigation Device” filed Dec. 8, 2006, and assigned to the assignee hereof and hereby expressly incorporated by reference herein.

### FIELD

The present disclosure relates to mobile navigation devices and more specifically to mobile navigation devices for presenting advertisements and measuring the effectiveness of the advertisements and providing to the advertisers information on the effectiveness of their advertising.

### BACKGROUND

Global Positioning Systems (“GPS”) enable a device to determine its location on the surface of the Earth. Many devices have been developed that utilize GPS to assist a user in navigating to their destination. A service for the user and a source of revenue for service providers is presenting advertisements to the user of the mobile navigation device. Some of the advertisements are selected based on the current location of the mobile navigation device. Often, the mobile navigation device is enabled to give navigational instructions to a location associated with the advertisement. For example, a user of the mobile navigation may request a list of nearby restaurants. Advertisements for nearby restaurants can be displayed and the user can request navigational instructions to the location of the advertised restaurant. One such device is U.S. Pat. No. 6,360,167 entitled “Vehicle Navigation System With Location-Based Multi-Media Annotation,” incorporated in its entirety herein by reference, which provides for presenting advertisements to a user based on the location of the mobile navigation device, and provides for giving navigational instructions to a location associated with the advertisement to the user. Advertisements can be solicited by the user, e.g. the person can request a listing of nearby restaurants, or the advertisements can be unsolicited by the person, e.g. a person walking past a bookstore carrying such a navigational device can be presented with an advertisement on the device that shows or states that the book store is currently having a 10% off sale.

Online advertisers advertising via the Internet often pay for the advertisements to be presented to the user. The advertisers would like to know how effective their advertisements are so that they can develop more effective advertising and so that they can determine whether the price paid to the service provider for presenting the advertisement to the user is cost effective. The service providers would like to know how effective the advertisements are so that they set prices for presenting the advertisements. The advertisers would like to know how effective the advertisements are so that they can evaluate whether the price paid for the advertising is cost effective. On a personal computer connected to the Internet, the success of some advertisements is measured by whether or not the user clicks on the advertisement. The click on the advertisement can be measured by a software program such as a browser and is reported to the service provider that supplied the advertisement. The service provider often will provide the paying advertiser with reports on the effectiveness of the advertisements. The price of the advertisement can be based on the number of times a user clicks on the advertisement. The ability to measure the effectiveness of the advertisement provides the service provider with more pricing options to offer the advertiser. One problem with the Internet connected PC based solution is that since the browser only measures when a user actually clicks on a presented advertisement that advertisers have been less willing to pay for brand awareness advertising. So, for instance, advertisers have been less willing to pay for promoting a national chain of pizza restaurants as it is difficult to measure the effectiveness of the brand advertising.

In contrast, on mobile navigation devices, which includes commercial points of interest data or advertisements associated with a location, there is currently no mechanism or method for an advertiser to measure the effectiveness of an advertisement presented on the mobile navigation device to the user. Accordingly, it would be advantageous to provide methods and apparatus that allow for measuring the effectiveness of advertisements presented to the user of mobile navigation devices.

### SUMMARY

The present disclosure provides a method and a system to measure the effectiveness of presenting an advertisement on mobile navigation devices. One embodiment is based on whether a user of the mobile navigation system responds to the advertisement by computing a route to a location associated with the advertisement. Another embodiment tracks whether a user of the mobile navigation system responds to an advertisement by computing a route to a location associated with the advertisement and actually travels to a location associated with the advertisement. A still further embodiment may simply compare whether, after a user is presented with an advertisement, the user goes to one or more locations the advertiser has previously associated with the advertisement. The effectiveness of the advertisement may also be measured and based on whether the user of the mobile navigation system visits a competitor location fewer times after an advertisement is presented.

In another embodiment, an apparatus for determining the effectiveness of an advertisement presented on a mobile navigation system based on the location of the mobile navigation system after the advertisement is presented includes a GPS receiver, an antenna coupled to the receiver for processing signals from GPS satellites to determine the current location of the mobile navigation system based on the received signals from the GPS satellites. The apparatus further includes a communication device operable to send to a remote server a current location of the user, and to receive from the server an advertisement based on the current location. In this embodiment, the apparatus further comprises an output computer device operable to present the advertisement to the user and an advertisement effectiveness module operable to determine the effectiveness of an advertisement based on comparing the current location of the user to a location associated with the advertisement.

In another embodiment, the apparatus may include a vehicle-mounted or hand-held GPS navigation device that has a database containing predetermined points of interest and advertisements, a GPS receiver, a communication device capable of communicating to a server, and a software program operable to track displayed points of interest and advertisements along with computed destinations and actual destinations reached that are associated with the displayed points of interest or advertisements.

Still other objects and advantages of the present disclosure will become readily apparent to those skilled in the art from the following detailed description, wherein embodiments of the disclosure are shown and described. As will be realized, the disclosure is capable of other and different embodiments, and its several details are capable of modifications in various obvious respects, all without departing from the scope of the present disclosure. Accordingly, the drawings and description thereof are to be regarded as illustrative in nature, and not as restrictive.

### BRIEF DESCRIPTION OF THE DRAWINGS

FIG. 1 is a representative diagram of one embodiment of a system for measuring the effectiveness of an advertisement presented on a mobile navigation device.

FIG. 2 is a representative diagram of one embodiment of the GPS system of FIG. 1.

FIG. 3 is a representative diagram of one embodiment of the system of FIG. 1.

FIG. 4 is a schematic diagram of an example of an advertisement being presented on the mobile navigation device.

FIG. 5 is a schematic diagram of an example of an advertisement being presented on the mobile navigation device.

FIG. 6 is a schematic diagram of an example of four locations associated with measuring the effectiveness of an advertisement presented on a mobile navigation device.

FIG. 7 is a flowchart of one embodiment of a method on an apparatus for determining the effectiveness of an advertisement presented on a mobile navigation device.

FIG. 8 is a table of an example of an effective report for an advertisement presented on a mobile navigation device.

FIG. 9 is a flowchart of one embodiment of a method on an apparatus for measure the effectiveness of an advertisement presented on a mobile navigation device.

FIG. 10 is a flowchart of another embodiment of a method for measuring effectiveness of an advertisement on a mobile navigation device in accordance with the present disclosure.

FIG. 11 is a flowchart of another embodiment of an advertisement effectiveness measurement scheme in accordance with the present disclosure.

### DETAILED DESCRIPTION

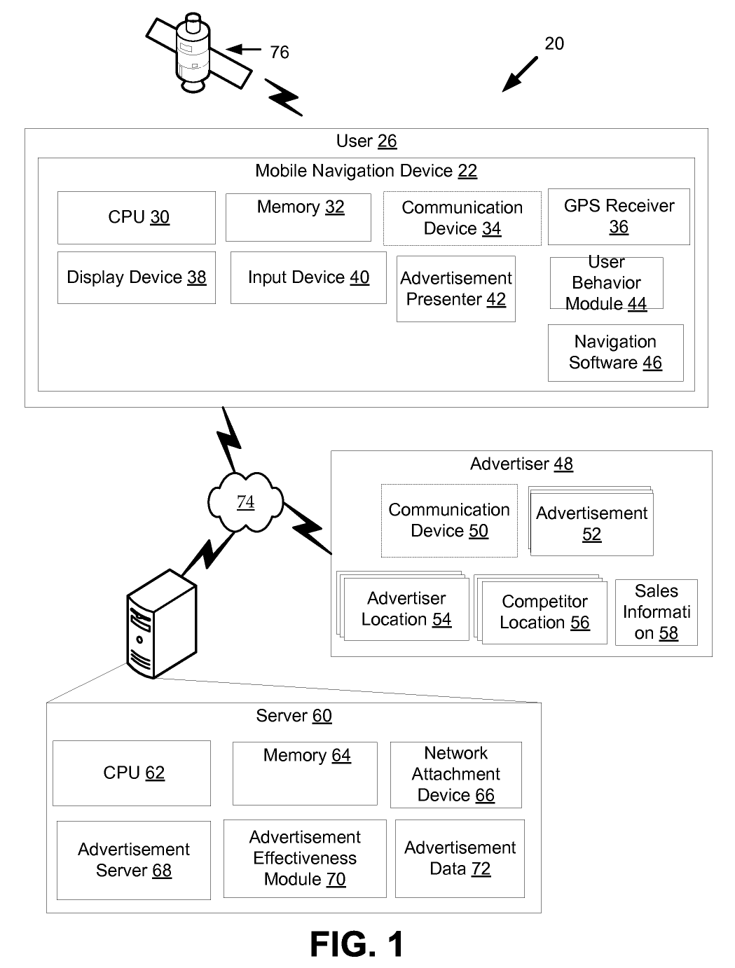

FIG. 1 depicts one embodiment of a system 20 for measuring the effectiveness of advertisements presented on a mobile navigation device 22. This system 20 basically includes a user 26 with a navigation device 22, an advertiser 48, a server 60, all linked together via a communication network 74. The effectiveness of presenting the advertisement 24 to a user 26 of the mobile navigation device 22 in this embodiment is measured at least partially based on determining whether the user 26 went to an advertiser location 28 associated with the advertisement 24.

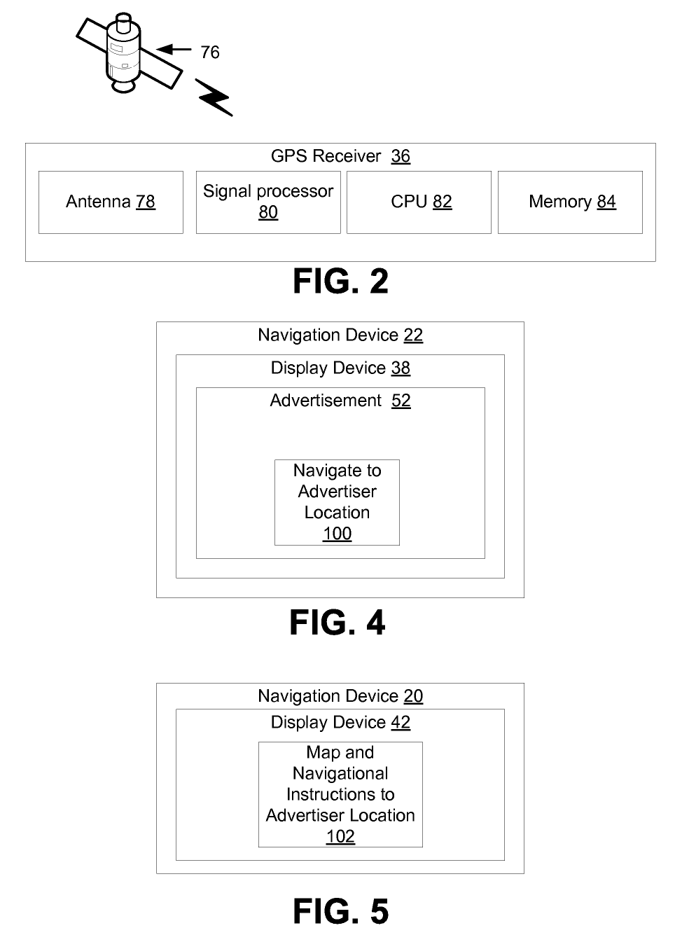

The user 26, in this embodiment, carries, or has in his/her vehicle, a mobile navigation device 22. The user 26 may be a person such as the driver of a vehicle, a passenger of a vehicle, or a pedestrian. The mobile navigation device 22 may include a CPU 30, memory 32, a communication module 34, a GPS receiver module 36 (described in reference to FIG. 2), a display 38, and an input module 40, all of which are communicatively coupled with one another. The mobile navigation device 22 further includes one or more advertisements in an advertiser module 42, a user behavior module 44 and navigation software 46 disposed in the memory 32. The CPU 30 is a central processing unit (“CPU”) for processing the instructions and data contained in the memory 32. The memory 32 includes random access memory (“RAM”), and non-volatile storage of read-only memory (“ROM”), or alternatively may include a hard-disk, or flash memory storing the needed data. Alternatively, the memory 32 may include remotely located and accessed data storage that is accessed as needed by the mobile navigation device 22 by using the communication module 34. The display 38 is preferably an LCD display or alternatively may be or include a speaker giving voice commands and information to the user 26. The input device 40 may be a touch screen or alternatively a microphone coupled to the CPU 30 programmed for voice recognition. Alternatively the input device 40 may be a keyboard or simplified keypad. Further, in some embodiments the display 38 and the input device 40 can be remotely located and in communication with the mobile navigation device 22 over the communication module 34. For example, the display 38 could be a home computer LCD monitor and the input device 40 could be a mouse coupled to the home computer with a friend of the user 26 remotely aiding the user 26 in navigating. The communication module 34 preferably includes a transceiver and an antenna for transmitting and receiving signals such as GSM, or alternatively a local area network (LAN) signals through protocols such as 802.11, and may be a cell phone communicating with the navigation device 22. Alternatively, the communication module 34 may be shared with the GPS receiver 38. For example, in an exemplary embodiment, a single antenna is shared by the mobile navigation device 22, the communication module 34, and the GPS receiver 38.

The advertiser 48 in the system 20 preferably includes a communication device 50, an advertisement 52, an advertiser location 54, and may also include a competitor location 56, and sales information 58. The advertiser 48 may be a business, a business establishment, or person. The advertisement 52 may include video, a still image, text, and/or audio content. The advertiser location 54 is an advertiser location on Earth associated with the advertisement 52 that the advertiser 48 would like the user 26 to visit. In some embodiments, the advertiser location 54 is the same as the location of the advertiser 48, e.g. the advertiser 48 can be a local pizza restaurant and the advertiser location 54 is the location on Earth, i.e. GPS coordinates, of the pizza restaurant. The competitor location 56 may be a location on Earth that the advertiser 48 does not want the user to visit, e.g. the competitor location 56 can be the location of a competing pizza restaurant. In some embodiments, there may be no competitor locations 56. The sales information 58 is recorded by the advertiser 48. The sales information 58 is information relating to the sale of products or services associated with the advertisement 52 and the user 26. In some embodiments, the sales information 58 is not associated with the user 26, but includes the volume of sales for a time period. The communication device 50 is computer with a connection to the Internet. Alternatively, in some embodiments the communication device 50 is a telephone.

The server 60 includes a CPU 62, a memory 64, and a network attachment device 66, all of which are communicatively coupled with one another. The server 60 further includes an advertisement server 68 disposed in the memory 64, an advertisement effectiveness module 70 disposed in the memory 64, an advertisement data 72 disposed in the memory 64. The CPU 62 is a central processing unit (“CPU”), or alternatively any device disposed for processing the instructions and data contained in the memory 64. The memory 64 is random access memory (“RAM”), and non-volatile storage of read-only memory (“ROM”), or alternatively a hard-disk, or flash memory. Alternatively, the memory 64 is remotely located and accessed by the server 60 by using the network attachment device 66. The network attachment device 66 is an Ethernet card for communicating with the communication network 74.

The communication network 74 may be the Internet, or may include a LAN for communicating with the server 60, and an attachment for communicating with the mobile navigation device 22, and an attachment for communicating with the advertiser 48. In one embodiment, the communication network 74 includes a LAN connected to the Internet.

FIG. 2 depicts the GPS receiver 36, which includes an antenna 78, a signal processor 80, CPU 82, and a memory 84. GPS systems 36 are well-known in the art. The antenna 78 is for receiving signals from the GPS satellite constellation 76. The signal processor 80 is for processing the signals received from the GPS satellite constellation 76 into a digital format that the CPU 82 can process. The GPS system 36 includes a separate CPU 82 and memory 84 enabled to process the signals received from the satellite constellation and calculate a location on the surface of the Earth based on the received signals. Alternatively, the GPS system 36 shares one or more of the antenna 78, the signal process 80, the CPU 82, and the memory 84, with the mobile navigation system 22 (depicted in FIG. 1).

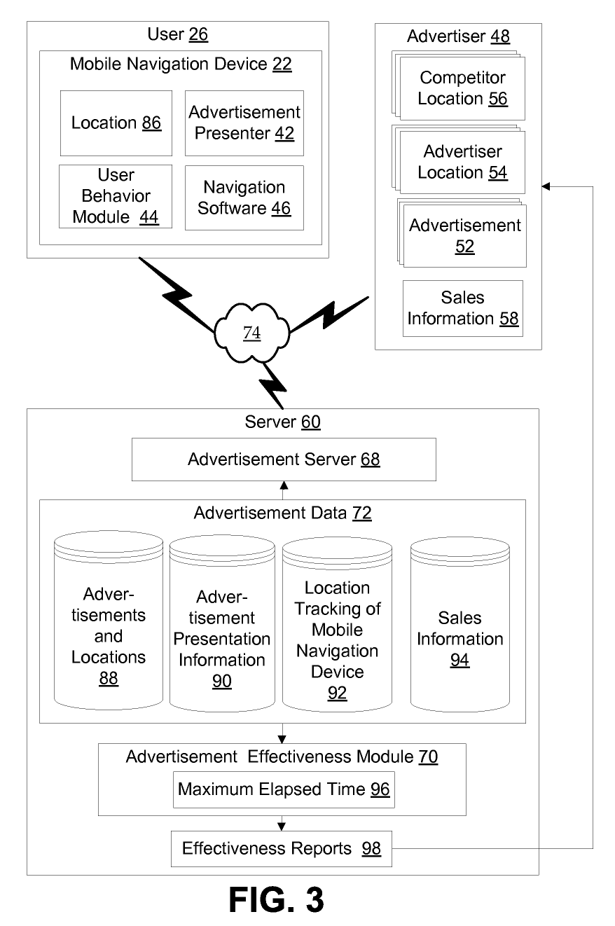

FIG. 3 depicts the user 26 including the mobile navigation device 22. The mobile navigation device 22 including location 86, navigation software 46, advertisement presenter 42, and record user behavior 44. The navigation software 46 is well known in the art and is arranged to guide the user 26 from the location 86 to a destination location. The advertiser presenter 42 receives advertisements 52 from the server 60. The advertiser presenter 42 presents advertisements to the user 26 on the mobile navigation device 22. After presenting the advertisement 52, the advertiser presenter 42 sends to the server 60 the chronological time the advertisement 52 was presented to the user 26 and the location 86 of the mobile navigation device 22 at the time the advertisement 52 was presented. In some embodiments, the user 26 is given the option to be given navigational instructions to an advertiser location 54. The record user behavior 44 tracks the location 86 of the mobile navigation device 22 and reports to the server 60 the locations 86 and the chronological time. If the user 26 elects to be given navigational instructions to an advertiser location 54, then the record user behavior 44 reports this to the server 60. In some embodiments, the user 26 may select a category of interest, e.g. restaurants, before the advertisement is presented to the user 26. Record user behavior 44 reports the selection of the category to the server 60. In some embodiments, record user behavior 44 reports some or all of the user interaction between the mobile navigation device 22 and the user 26.

The advertiser 48 includes competitor location 56, advertiser location 54, advertisement 52, and sales information 58. The advertiser 48 sends to the server 60 advertiser location 54, and advertisement 52. In some embodiments, the advertiser 48 sends sales information 58 and competitor location 56.

The server 60 includes advertisement data 72, advertisement server 68, advertisement effectiveness module 70, and effectiveness reports 46. The advertisement data 72 includes advertisements and associated locations 88, advertisement presentation information 90, location tracking of mobile navigation device 92, and sales information 94. It should be understood that although advertisement data 72 is depicted as having a particular organization for ease of discussion that the data itself may be organized differently. For example, in some embodiments all the data in advertisement data 72 resides in a single database.

The advertisements and associated locations 88 includes advertisements 52 for presentation, and locations 86 associated with the advertisements 52. The advertisement presentation information 90 includes information about which advertisements 52 were presented, at what time the advertisements 52 were presented, on which mobile navigational device 52 the advertisements 52 were presented, and to which user 26 the advertisement 52 was presented. The location tracking of mobile navigation device 92 includes information about the location of the mobile navigation device 92 and whether the user 26 selected navigational instructions to an advertiser location 54 associated with an advertisement 52, and in some embodiments a competitor location 56 associated with an advertisement 52.

The sales information 94 includes information about sales information 94 the user 26 made associated with an advertisement 52. In some embodiments, the advertisement data 72 is partially stored locally and partially stored remotely.

The advertisement server 68 receives and stores the data regarding advertisement data 72 from the advertiser 48 and the mobile navigation device 22. The advertiser server 68 receives a location 86 from the mobile navigation device 22 and based at least partially on the location 86 sends an advertisement 52 to the mobile navigation device 22 for presentation to the user 26. In some embodiments, the advertisement server 68 may base the selection of the advertisement 52 on a category the user 26 has selected on the mobile navigation device 22, e.g. restaurants. Further, the advertisement server 68 may base the selection of the advertisement 52 based on the effectiveness report 98. For example, an advertiser 48 may have a plurality of advertisements 52 that could be presented to the user 26, e.g. three different advertisements 52 for the same pizza restaurant, and the advertisement server 68 can select which of the three advertisements 52 to present to the user 26 based on the effectiveness report 98 for each of the advertisements 52.

The advertisement effectiveness module 70 includes maximum elapsed time 96. The advertisement effectiveness module 70 is arranged to evaluate the effectiveness of the advertisements 52 presented to the user 26 and generate an effectiveness report 98. In some embodiments, to measure the effectiveness of an advertisement 52, the advertisement effectiveness module 70 reads the information in advertisement presentation information 90 to determine the number of times the advertisement 52 was presented and whether or not the user 26 presented the advertisement 52 selected navigational instructions to an advertiser location 54. The advertisement effectiveness module 70 then compares location tracking of mobile navigation device 92 to determine whether the mobile navigation device 22 actually arrived at the advertiser location 54 associated with the advertisement 52. In some embodiments, the effectiveness of the advertisement 52 is the percentage of time the mobile navigation device 22 arrived at the advertiser location 54. The maximum elapsed time 96 includes a time to use for determining whether the mobile navigation device 22 arrived at the advertiser location 54. For example, maximum elapsed time 96 can be one day where the advertisement effectiveness module 70 is assuming that if the mobile navigation device 22 did not arrive at the advertiser location 54 in one day then the advertisement 52 was not successful. In some embodiments, the advertisement effectiveness module 70 will measure the effectiveness of the advertisement 52 based on whether or not the mobile navigation device 22 arrived at competitor locations 56 a fewer number of times for some predetermined amount of time after an advertisement 52 has been presented on the mobile navigation device 22.

It should be understood that although the functionality provided by separate modules has been divided up into a particular organization for ease of discussion that the functionality provided may be organized differently. For example, in some embodiments a single module may be arranged to provide all the functionality of both advertisement server 68 and advertisement effectiveness module 70. Additionally, the functionality provided by the modules residing both on the server 60 and the mobile navigation device 22 may be divided differently between the server 60 and the mobile navigational device 22. For example, in some embodiments the mobile navigation device 22 includes an advertisement server 68.

FIG. 4 depicts an advertisement 52 being presented on a navigation device 22. The display device 38 is also displaying an option for the user 26 to select “Navigate to Advertiser Location” 100. This option would provide navigation instruction from the location 86 to the advertiser location 54 provided by the navigation software 46 (FIG. 3). FIG. 5 depicts the results of the user 26 selecting “Navigate to Advertiser Location” 100. The user 26 is provided with “Map and Navigational Instructions to Advertiser Location” 102. For example, the advertisement 52 can be an advertisement 52 for a pizza restaurant, and the option for navigation instructions could read, “Hit Here to Get a Pie!” After selecting the option for navigation instructions 100 the mobile navigation device 22 provides navigational instructions from location 86 to the pizza restaurant.

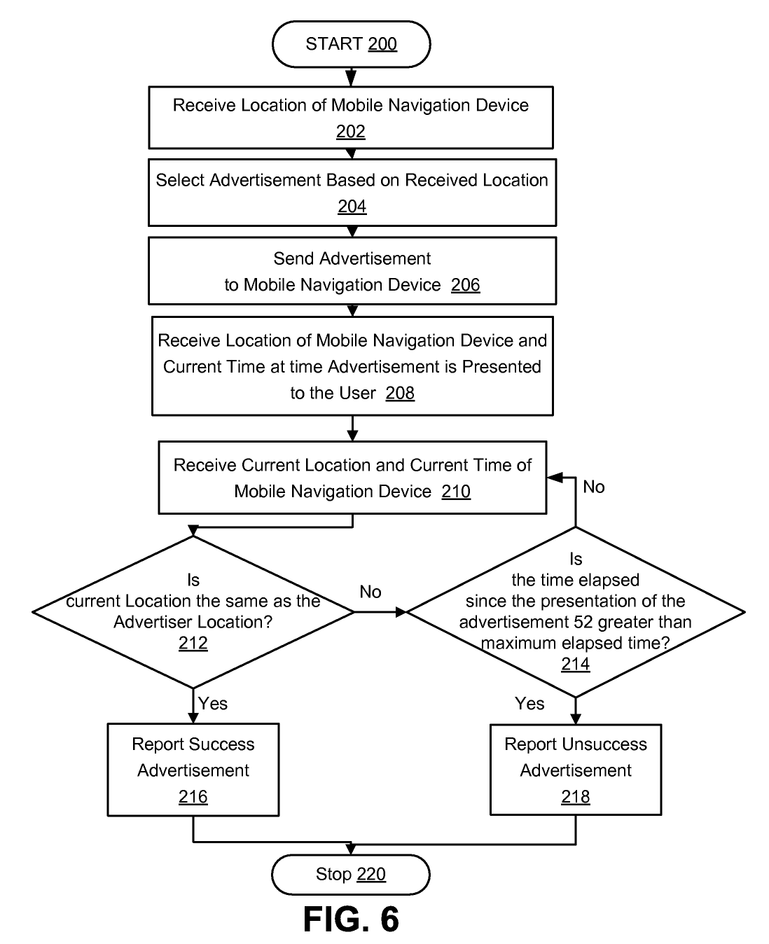

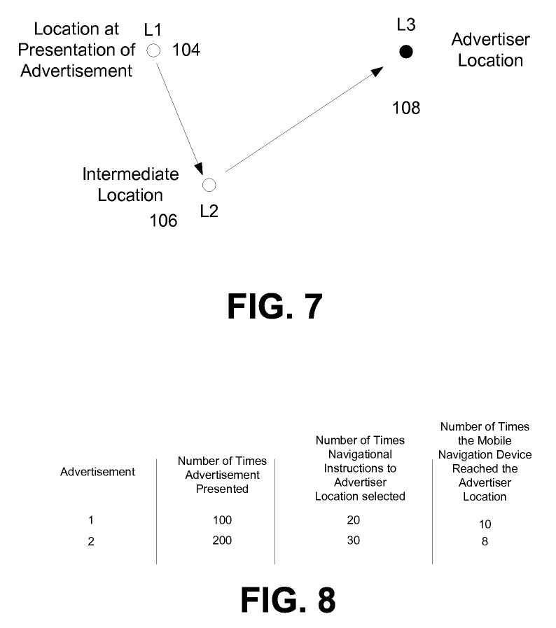

FIGS. 6, 7, and 8 depict an illustrative example of using one embodiment of the system 20 of FIGS. 1, 2, and 3. The flow starts in FIG. 6 at Block 200. The flow proceeds to Block 202 with receive location of mobile navigation device 22. The mobile navigation device 22 is at L1 of FIG. 7 and sends the location L1 to the server 60. The advertisement server 68 receives the location 86 of the mobile navigation device 22. The flow proceeds to Block 204. Select advertisement 52 based on received location 86. The advertisement server 68 selects an advertisement 52 to send to the mobile navigation device 22. The flow proceeds to Block 206 send advertisement to mobile navigation device 22. The advertisement server 68 sends the advertisement 52 to the mobile navigation device 22. The flow proceeds to Block 208 receive location of mobile navigation device and current time at time advertisement is presented to the user. For purposes of illustration, it is assumed that the mobile navigation device 22 presented the advertisement at L1 104 and sent location L1 to advertisement server 68. The mobile navigation device 22 also sent the time when the advertisement 52 was presented on the mobile navigation device 22 to the advertisement server 68. The flow proceeds to Block 210 receive current location 86 and current time of mobile navigation device 22. The mobile navigation device 22 is now at L2 106 of FIG. 7. The mobile navigation device 22 sends the current time and the current location L2 to the advertisement server 68. The flow proceeds to Block 212 is current location the same as the advertiser location? The current location received is L2 and the advertiser location is L3, so the answer is no. The flow proceeds to Block 214 is the time elapsed since the presentation of the advertisement 52 greater than maximum elapsed time 96? Here, it is assumed the answer is no. The flow returns to Block 210 receive current location 86 and current time of mobile navigation device 22. The mobile navigation device 22 is now at L3 108 of FIG. 7. The mobile navigation device 22 sends the current time and the current location L3 to the advertisement server 68. The flow returns to Block 212 is current location the same as the advertiser location? L3 is the same as L3, so the mobile navigation device 22 has arrived at the advertiser location 54. The flow proceeds to Block 216 report success advertisement 52. The report of the successful advertisement 52 is made to the effectiveness report 98. Back in Block 214 if the answer had been yes that the time elapsed since the presentation of the advertisement 52 is greater than maximum elapsed time 96, then a report of an unsuccessful advertisement 52 is made to the effectiveness report 98.

FIG. 7 is one example of an effectiveness report 98. The first column, “Advertisement” is some type of identification that uniquely identifies the advertisement 52. The advertisement 52 could be for a local pizza restaurant. The second column, “Number of Times Advertisement Presented” is the total number of times the advertisement has been presented to all users 26. The third column, “Number of Times Navigational Instructions to Location Selected” is the number of times the user 26 has selected the option of being given navigational instructions to the advertiser location 54. The fourth column, “Number of Times the Mobile Navigation Device Reached the Location Associated with the Advertisement” is the number of times the advertiser location 54 and the location 86 of the mobile navigation device 22 was the same. The effectiveness could then be said to be the number of times the mobile navigational device 22 reached the advertiser location 54 associated with the advertisement 52.

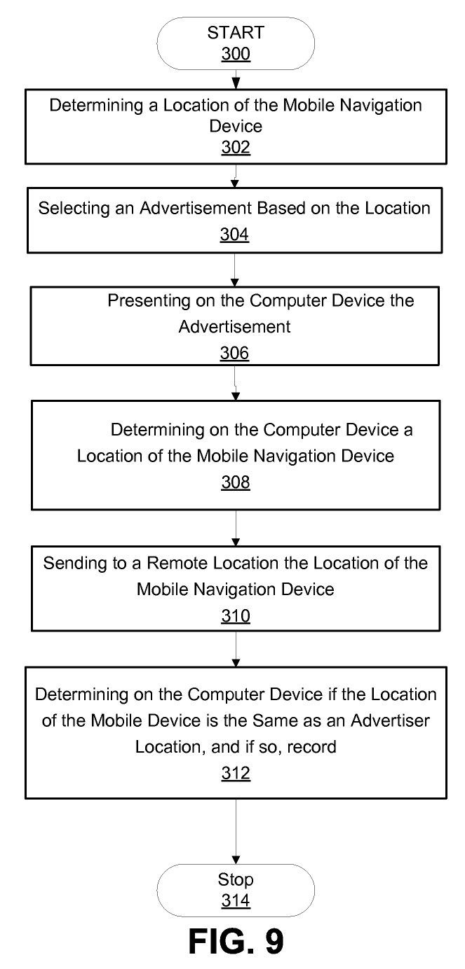

FIG. 9 depicts an embodiment of a method that is performed by the system of FIG. 1 for measuring the effectiveness of advertisements presented on a mobile navigation device 22. The flow starts at Block 300. The flow continues with Block 302 determining at a computer device a location 86 of the mobile navigation device 22. The location 86 is determined by the GPS system 40 of FIG. 2. The flow proceeds to Block 304 selecting an advertisement 52 based on the location 86. In an embodiment, the advertisement 52 is selected locally by the mobile navigation device 22, or alternatively, the advertisement 52 is selected remotely by the server 60 and sent across the communication network 74 to the mobile navigation device 22. The flow proceeds to Block 306 presenting on the computer device the advertisement 52. The advertisement 52 is presented on the display device 38 for consumption by the user 26. The flow proceeds to Block 308 determining the current location 86 of the mobile navigation device 22. The location 86 is determined by the GPS system 40 of FIG. 2. The flow proceeds to Block 310 sending to a remote location the current location 86 of the mobile navigation device 22. The location 86 is sent by the mobile navigation device 22 to the server 60 over the communications network 74. The flow proceeds to Block 312 determining if the location 86 of the mobile navigation device 22 is the same as an advertiser location 54. In some embodiments, the server 60 determines if the location 86 of the mobile navigation device 22 is the same as an advertiser location 54. Alternatively, the mobile navigation device 22 determines if the location 86 of the mobile navigation device 22 is the same as an advertiser location 54.

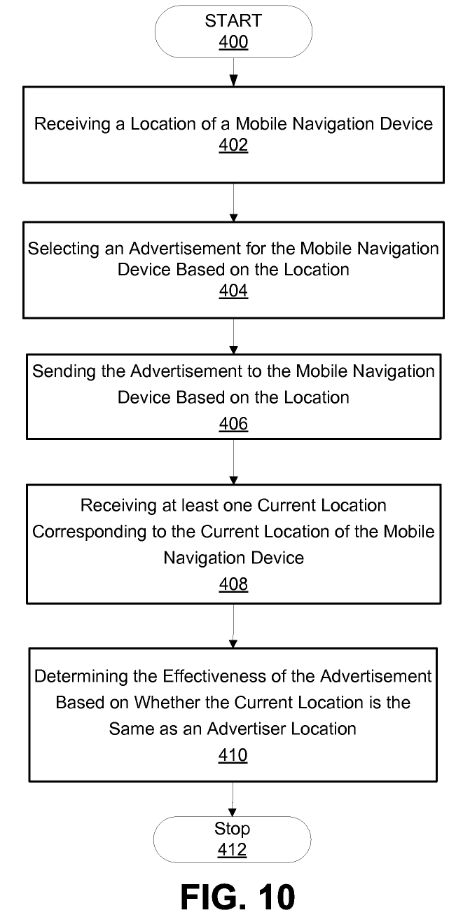

FIG. 10 depicts an embodiment of a method that is performed by the system of FIG. 1 for measuring the effectiveness of advertisements presented on a mobile navigation device 22. The flow starts at Block 400. The flow continues with Block 402 receiving a location 86 of a mobile navigation device 22. The location 86 is received by the mobile communication device 22 and stored by the advertisement server 68 of FIG. 3. The flow proceeds to Block 404 selecting an advertisement 52 based on the location 86. The advertisement server 68 selects an advertisement 52 based on the location 86. The flow continues with Block 406 sending the advertisement 52 to the mobile navigation device 22 based on the location 86. The flow proceeds to Block 408 receiving at least one current location 86 corresponding to the current location 86 of the mobile navigation device 22. The flow continues to Block 410 determining the effectiveness of the advertisement 52 based on whether the current location 86 is the same as an advertiser location 54. The advertisement effectiveness module 70 of FIG. 3 is arranged to determine the effectiveness of the advertisement 52 based on whether the current location 86 is the same as an advertiser location 54. In this embodiment, the determination of the effectiveness of the advertisement 52 is performed on the mobile navigation device 22.

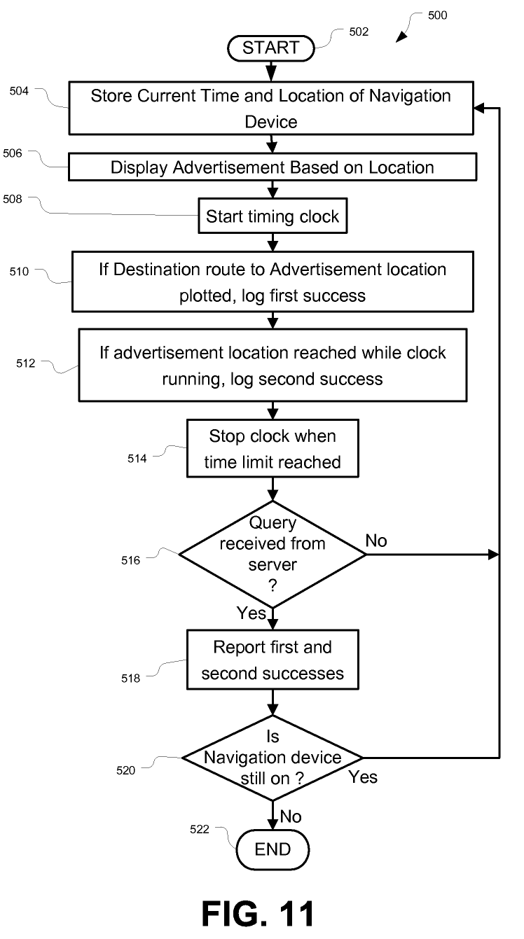

Another embodiment of a method of determining the effectiveness of advertisements in accordance with the present disclosure is presented in FIG. 11. Here all data logging is done by the mobile navigation device 22. Subsequently, at various times, a query is made by server 60 via the network 74 to gather and transfer data on the successes logged by the navigation device 22. This information is then transferred to the server for subsequent handling and analysis by the advertisers 48. The advertisers 48 may receive reports periodically from the server 60 or may retrieve such reports upon querying the server 60.

In this embodiment 500, there are two categories of successful events logged by the navigation device 22. The first successful event is when an advertisement is displayed to a user 26 and the user either displays the location of the advertisement or utilizes the navigation device 22 to calculate a route to the location associated with the advertisement. For example, the advertisement may be simply a displayed point of interest or “POI”. If the user then taps, or clicks on, or touches the POI, then either a close-up map of the location is displayed, or a route to it is calculated, depending on the mode of operation of the navigation unit that is currently in. If any one of these events happens, a first success data-point is logged in the navigation device memory. At the same time, a clock timer is started. If, during the running of the timer, the navigation device 22 senses that its current location matches the location associated with that advertisement, then a second success data-point is logged in the memory of the navigation device 22. Then, preferably at times dictated by the server 60, the navigation device 22 may be queried for a transfer of data from device memory for subsequent communication to and analysis by the particular advertiser 48.

This capability of the navigation device 22 may preferably be activated or blocked by the user 26 at his or her discretion. However, the user 26 may be encouraged to enable this advertising information gathering functionality by incentives provided by the advertisers or by the mobile navigation device 22 providers. Alternatively, the user 26 may simply accumulate the data-points over a substantial period of time and then permit a service provider such as the advertiser or device provider to receive the data only at times selected by the user 26, such as monthly or whenever a navigation device mapping update is desired. In this way the user 26 would have more control over dissemination of the advertisement effectiveness information. Alternatively the advertiser 48 may be provided with control over the data transfer frequency in exchange for preferred rates, coupons, etc. provided to the user 26. Alternatively, the information transfer may be completely transparent to the user 26. It is therefore intended that all such schemes are encompassed within the present disclosure.

Referring now specifically to FIG. 11, exemplary operation of an exemplary software routine within the navigation device 22 will be described. This routine 500 begins in start operation 502 when the mobile navigation device 22 is powered on. At this point in the routine 500 registers are initialized, the GPS receiver 36 is activated, a current location is determined and displayed on display 38. Control then transfers to operation 504.

In operation 504, a current time stamp and current location is stored in memory 32. An advertisement database is then searched for advertisements associated with the current location, associated with a destination provided by the user 26, or as a result of click-throughs to a particular POI as discussed above. Then control transfers to operation 506.

In operation 506, an advertisement is displayed, or a POI displayed on the navigation device 22 display 38. Each advertisement displayed or POI displayed, has associated with it a GPS location. The location parameters stored for the advertisement or POI preferably represent a vicinity of the desired location rather than exact location data. This is because the navigation device 26 may not actually go to the exact location, but more likely may be in a vehicle that must be parked nearby to permit the user 26 to go to the actual location. Thus, the location data should reflect, for example, a location radius of 0.1 to 0.5 miles from the actual destination location. Once the advertisement or POI is displayed on display 38, control transfers to operation 508.

In operation 508, if an advertisement has been identified, or a particular POI determined in operation 504, then a timing clock is started. This timing clock is utilized to set a reasonable travel time association with travel to a POI or destination that the user 26 has punched in or otherwise entered into the navigation device 22. For example, if the user 26 selected restaurants and tapped on a restaurant within 5 miles of his current location and dialed that restaurant in as a destination, and the device 22 determines that it would take between 15 and 30 minutes to travel that distance, then the clock might be set for one hour. If the location was 125 miles away the clock would likely be set for additional time, such as 3 hours, or even 24 hours. Alternatively the clock may default to 24 hours in each case. In addition, the location of the advertisement or POI is stored in memory 32. Control then transfers to operation 510.

In operation 510, when the POI is displayed, this indicates that the user 26 is considering going to the POI location. Similarly, if the user 26 calculates a route to the advertisement or POI location, this indicates that the user 26 has an interest in that location or that advertisement. Accordingly, a first success count is stored in memory 32 along with the location of the advertisement or POI. Control then transfers to operation 512.

In operation 512, if the location associated with the advertisement or POI is reached within the time limit of the clock started in operation 508, then a second success count is stored associated with that advertisement or POI. This information is extremely useful to the advertiser as it indicates that not only was the advertisement of interest to the user 26, but significant enough such that the user 26 actually went to the location associated with the advertisement 52. However, if the user 26 went to the location after the timer has expired, this would likely indicate that there may have been a reason, other than advertisement effectiveness, that caused the user 26 to reach that destination. Control then transfers to operation 514.

In operation 514, the clock is stopped when either the destination association with the advertisement is reached by the user 26, or the predetermined time period has elapsed. The primary purpose for running a clock during operation 504 through 512 is to eliminate those instances where association between the advertisement and user's travel are likely to be unrelated. For example, let us assume that the user sees an ad on display 38. The following week he travels to the location that is associated with the ad previously seen. It is likely that this event is not associated with the ad seen the week previously on the display 38, but more likely to be associated with an ad on display 38 immediately before traveling there. Thus there is a need for a time limitation to be associated with the advertisement display and result in order to eliminate stale responses. Hence preferably the clock has a span of about 24 hours or less. Control then transfers to query operation 516.

In query operation 516, the software asks whether the server has polled the device 22. If so, control transfers to operation 518. If not, control transfers back to operation 504 where the system stores another current time and the current location of the navigation device 22, and operations 504 through 516 are again repeated. This process is repeated so long as the device 22 is on, until a query is received from the server 60. When this occurs, control transfers to operation 518.

In operation 518, the log of first and second responses is transmitted to the server 60. This may be done wirelessly via network 74, or may be done by connecting the device 22 to an upload link or server 60 directly, say, when an update of software is to be downloaded to the navigation device 22. The data that is stored, first and second responses, is stored along with data that indicates with which advertisement it is associated as well as the time stamps of occurrences of first and second successes. Other data may also be transmitted such as vehicle starting locations, time between first and second response, etc. In addition, data may be stored and transferred to the server 60 related to the POIs and advertisements that were displayed but not selected as destinations by the user 26. This information may be utilized by the advertiser 48 to further evaluate effectiveness of advertisements 52 in relation to competitors and their locations 56. Control then transfers to query operation 520.

In query operation 520, the query is made whether the navigation device 22 is still in operational mode. If so, then control transfers back to operation 504 as discussed above. If not, then control transfers to operation 522 where the process ends. This process 500 is preferably one that may be run in the background whenever the device 22 is operational such that it is completely transparent to the user 26.

This method and system described in embodiment 500 may be incorporated into the software of currently existing mobile navigation system devices. It should now be apparent that a system has been described that measures the effectiveness of advertisements presented on a mobile navigation device 22. The effectiveness of presenting an advertisement 52 to a user 26 of the mobile navigation device 22 is measured at least partially based on determining whether the user 26 visited an advertiser location 54 associated with the advertisement 52.

It will be readily seen by one of ordinary skill in the art that the present disclosure fulfills all of the objects set forth above. After reading the foregoing specification, one of ordinary skill will be able to affect various changes, substitutions of equivalents and various other aspects of the disclosure as broadly disclosed herein. It is therefore intended that the protection granted hereon be limited only by the definition contained in the appended claims and equivalents thereof.

What is claimed is:

1. A method comprising:
determining a current location of a mobile navigation device from received global positioning system (GPS) signals;
selecting an advertisement or point of interest (POI) based on one or more of the determined current location and a potential destination;
displaying the advertisement or POI;
storing a first success if a user-selected destination matches a location associated with the advertisement or POI;
updating the current location of the mobile navigation device using GPS signals; and
conveying the first success to a server.

2. The method of claim 1 further comprising:
determining if the updated current location of the mobile device corresponds, within a predefined accuracy, to a location of the advertisement or POI location.

3. The method of claim 2 further comprising storing a second success when the updated current location of the mobile navigation device corresponds to the location of the advertisement or POI location.

4. The method of claim 1, further comprising the steps of:
receiving an indication the displayed advertisement was selected; and
determining navigational instructions from the current location of the mobile navigation device to the advertisement location.

5. The method of claim 4, further comprising:
starting a timing clock when navigational instructions to the advertisement location are determined.

6. The method of claim 5 further comprising storing a second success if the advertisement location is reached before the timing clock is stopped.

7. A method of measuring advertisement efficiency on a mobile navigation device comprising:
determining a current location of a mobile navigation device based on GPS signals;
querying a computing device for businesses and services close to the current location;
sending business and service advertisements close to the current location to the mobile navigation device;
a user of the mobile navigation device selecting one of the advertisements as a potential destination;
storing a first success associated with the selected destination of one of the advertisements; and
conveying the first success to the computing device.

8. The method of claim 7, further comprising:
selecting the advertisement based on the current location being the same as a competitor location, wherein the advertisement offers a discount.

9. The method of claim 7, wherein selecting the advertisement further comprises:
selecting the advertisement based at least on the current location and a previous location, wherein the previous location was a location of the mobile navigation device before the current location.

10. The method of claim 8, further comprising:
presenting to a mobile navigation device user a plurality of categories;
receiving from the user an indication of a selected one of the plurality of categories; and
selecting the advertisement based on the selected category.

11. An apparatus for measuring advertisement efficiency on a mobile navigation device, comprising:
a GPS receiver in a mobile navigation device communicatively coupled to an antenna;
a communication device coupled to the receiver operable to send to a server a current location, and further operable to receive an advertisement from the server based on the current location;
a display operable to present the advertisement to a user of the mobile navigation device; and
a software routine in the navigation device operable to determine the effectiveness of an advertisement based on comparing the current location to a location associated with the received advertisement.

12. A method of measuring advertisement efficiency on a mobile navigation device, comprising:
determining a location of a mobile navigation device;
selecting an advertisement to display on the mobile navigation device based on the device location;
displaying the advertisement; and
storing a first success if a user selects the location associated with the advertisement as a destination on the device.

13. The method of claim 12 further comprising:
monitoring a current location of the navigation device; and
storing a second success if the current location of the navigation device matches the location associated with the advertisement within a determined period of time.

14. The method of claim 13 wherein the period of time is determined by a clock in the mobile navigation device.

15. The method of claim 12 further comprising conveying the success to a computing device.

16. The method of claim 13 further comprising conveying first and second successes to a computing device.

17. The method of claim 16 wherein the successes are conveyed in response to a query from the computing device.

18. A computer-readable medium storing instructions which, when executed by a processor, cause the processor to perform steps of:
determining a current location of a mobile navigation device from received global positioning system (GPS) signals;
selecting an advertisement or point of interest (POI) based on one or more of the determined current location and a potential destination;
displaying the advertisement or POI on the navigation device;
storing a first success if a selected destination input by a user of the navigation device matches a location associated with the advertisement or POI; and
updating the current location of the mobile navigation device using GPS signals.

19. The medium of claim 18 wherein the processor further performs a step of:
storing a second success if the current location of the mobile navigation device corresponds with the location associated with the advertisement or POI within a determined period of time.

20. The medium of claim 19 wherein the processor further performs a step of conveying first and second successes to a computing device.
